(19) United States
(12) Patent Application Publication
(10) Pub. No.: US 2014/0143762 A1
(43) Pub. Date: May 22, 2014

(54) SYMBOLIC EXECUTION OF DYNAMIC PROGRAMMING LANGUAGES

(71) Applicant: FUJITSU LIMITED, Kawasaki-shi (JP)

(72) Inventors: Guodong LI, San Jose, CA (US); Indradeep GHOSH, Cupertino, CA (US)

(73) Assignee: FUJITSU LIMITED, Kawasaki-shi (JP)

(21) Appl. No.: 13/683,891

(22) Filed: Nov. 21, 2012

(51) Int. Cl. G06F 9/45

(52) U.S. Cl. CPC G06F 8/40; G06F 8/41
USPC 717/139

(57) ABSTRACT

A method of symbolically executing a dynamic program may include receiving a portion of a dynamic program that includes multiple objects. The method may also include symbolically executing the dynamic program including constraint solving by managing runtime states of the symbolic execution within a native symbolic executor. Managing the runtime states of the symbolic execution may include constructing an object map of two or more of the objects that are interdependent and distinguishing code portions of one of the two or more objects in the object map from data portions of the one of the two or more objects. Managing the runtime states of the symbolic execution may also include performing one or more of state copying, state backtracking, state sharing, and state spawning based on characteristics of the dynamic program using the object map and the distinguished code portions and data portions.

### FIELD

The embodiments discussed herein are related to symbolic execution of dynamic programming languages.

### BACKGROUND

A software program may be tested or validated manually or automatically. In the former case, a person (e.g., a software testing engineer) may manually design test cases for the software program based on the design specification of the program, execute the program under the test cases, and check for program behavior or output that does not agree with the specification of the program in view of the test cases. In the latter case, a software-testing tool, implemented as computer software or hardware, may automatically generate test cases for a software program under test, execute the program under test while simulating the test cases, and check for module behavior or output that does not agree with the specification of the program in view of the test cases. The sheer complexity of modern software programs often renders manual generation or design of test cases inadequate for completely testing the software programs. Additionally, the complexity of software programs developed using dynamic programming languages may render automatic testing and validation schemes developed for software programs using static programming languages inoperable.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of symbolically executing a dynamic program may include receiving a portion of a dynamic program that includes multiple objects. The method may also include symbolically executing the dynamic program including constraint solving by managing runtime states of the symbolic execution within a native symbolic executor. Managing the runtime states of the symbolic execution may include constructing an object map of two or more of the objects that are interdependent and distinguishing code portions of one of the two or more objects in the object map from data portions of the one of the two or more objects. Managing the runtime states of the symbolic execution may also include performing one or more of state copying, state backtracking, state sharing, and state spawning based on characteristics of the dynamic program using the object map and the distinguished code portions and data portions. The method may further include optimizing a function invocation by compiling the function into machine code, translating the function to a static one, using cached information, or applying summaries for the function.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example symbolic execution flow of an example program;

FIG. 2 is a block diagram of an example system for symbolically executing a dynamic program;

FIG. 3 illustrates a hierarchical memory structure of a portion of a dynamic program;

FIG. 4 illustrates a flat memory structure of a portion of a static program;

FIG. 5 is a flowchart of an example method of optimizing symbolic execution of a dynamic program;

FIG. 6 is a flowchart of an example method of symbolically executing a dynamic program; and

FIG. 7 is a flowchart of another example method of symbolically executing a dynamic program.

### DESCRIPTION OF EMBODIMENTS

Some embodiments described herein relate to methods of symbolically executing a dynamic program. A dynamic program may be a program that is written using a dynamic programming language. A dynamic programming language may be a programming language that executes at runtime many common behaviors that static programming languages may perform during compilation. Alternately or additionally, a dynamic programming language may be a programming language that executes behaviors at runtime that a static program may not perform. Some examples of dynamic programming languages include, but are not limited to, JavaScript, Perl, Python, Ruby, BASIC, Dylan, Fancy, Lua, and Lisp, among others.

In some embodiments, a dynamic programming language may differ from a static programming language by being dynamically typed. A programming language is dynamically typed when the variables within a program are not assigned types until runtime of the program. A type of a variable may include, but is not limited to, a Boolean, a character, a string, an integer, a float, a double, a pointer, an array, and an enumeration, among others. Thus, before a dynamic program is run or when a dynamic program is compiled, the type of the variables in the dynamic program and thus memory allocations for the variables is not known.

By not defining the types of variables in a dynamic program, the memory allocations for the variables are unknown before runtime. Furthermore, memory allocations for statements, functions, and data structures are also unknown before runtime. Variables, statements, functions, and data structures within a dynamic program may be referred to herein generally as “objects.” These objects may be connected together through scopes of the objects, where the scope of an object is defined at runtime. More details on how objects are connected through scopes are explained hereafter.

A dynamic program may be formally tested and validated. To formally test and validate a dynamic program, test input values may be assigned to input variables of the dynamic program and the output values resulting from the input variables may be analyzed to determine the behavior and validate the dynamic program. In some embodiments, symbolic execution may be used to automatically generate test input values to be used for testing the dynamic software.

Symbolic execution may refer to the analysis of software programs, such as a dynamic program or a static program, by tracking symbolic rather than actual values, as a case of abstract interpretation. It is a non-explicit state model-checking technique that treats input to software programs as symbol variables. It creates complex equations by executing all finite paths in the software program with symbolic variables and then solves the complex equations with a solver to obtain error scenarios, if any. In contrast to explicit state model checking, symbolic execution may, in some embodiments, be able to work out all possible input values and all possible use cases of all possible input values in the software under analysis. Thus, symbolic execution may exhaustively validate a software program under analysis.

To further explain symbolic execution, consider an example software program named “foo” written in a static language with static typing:

TABLE 1
Function Foo

| | |
|---|---|
| 1 | string foo (string a, string b) { |
| 2 | string c, d; |
| 3 | c = a + b; |
| 4 | if (c != “qrs”){ |
| 5 | d = c + “t”; |
| 6 | return d′ |
| 7 | } else { |
| 8 | return c; |
| 9 | } |
| 10 | } |

The software program “foo” has two input variables “a” and “b” and two program variables “c” and “d.” Program “foo” contains a conditional branching point at line 4 of the code, caused by the “if-else” statement. The conditional branching point at line 4 is associated with a branching condition “(c !=”qrs“).” Depending on whether this branching condition is satisfied or holds true—that is, whether the program variable “c” equals “qrs”—program “foo” proceeds down different execution paths and different portions of the code of program “foo” are actually executed. More specifically, if the program variable “c” does not equal “qrs,” then the value of the variable “d” is computed and returned, as indicated by lines 5 and 6 of the code. On the other hand, if the variable “c” does equal “qrs,” then the value of the variable “c” is returned, as indicated by line 8 of the code.

When symbolic execution is performed on program “foo,” its input variables and program variables are each assigned a symbolic value instead of an actual value.

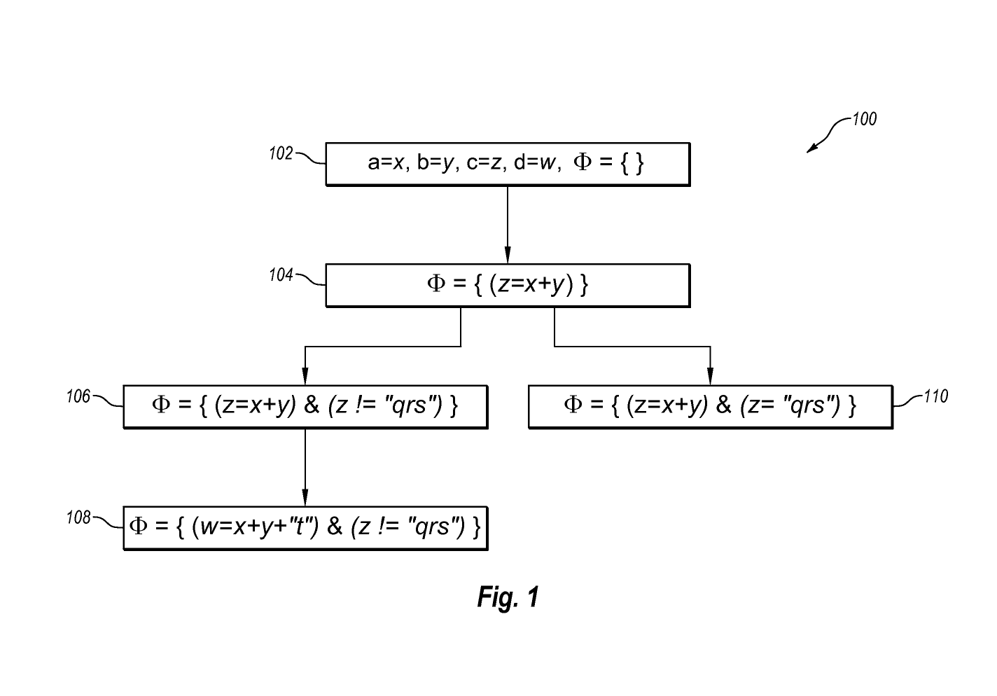

FIG. 1 illustrates an example symbolic execution flow 100 of the example program “foo,” arranged in accordance with at least some embodiments described herein. In this example, the input variable “a” is assigned symbolic value “x;” the input variable “b” is assigned symbolic value “y;” the program variable “c” is assigned symbolic value “z;” and the program variable “d” is assigned symbolic value “w.” Since the variables “a,” “b,” “c,” and “d” are of type “string,” symbolic values “x,” “y,” “z,” and “w,” each represent an arbitrary string.

In addition, “Φ” is the symbolic expression that represents the result of the symbolic execution at various points along the execution paths. More specifically, at 102, which corresponds to line 2 of the code of program “foo,” the variables “a,” “b,” “c,” and “d” are assigned their respective symbolic values “x,” “y,” “z,” and “w,” and “Φ” initially has an empty or null expression. As the execution proceeds further, expressions are added to “Φ” depending on what code has been executed. At 104, which corresponds to line 3 of the code of program “foo,” “Φ” has the expression “z=x+y” because line 3 of the code is “c=a+b” and “x,” “y,” and “z” are the symbolic values assigned to variables “a,” “b,” and “c,” respectively. Next, line 4 of the code of program “foo” is a conditional branching point and there are two possible execution paths down which the execution may proceed. Thus, the symbolic execution may also proceed down two different paths from 104: the first path, PATH 1, includes 106 and 108 corresponding to lines 5 and 6 of the code; and the second path, PATH 2, includes 110 corresponding to line 8 of the code.

In order to proceed down PATH 1, the program variable “c” does not equal “qrs,” which means symbolic value “z” does not equal “qrs.” Therefore, the expression “z !=”qrs“” is added to “Φ” at 106. Conversely, in order to proceed down PATH 2, the program variable “c” does equal “qrs,” which means symbolic value “z” equals “qrs.” Therefore, the expression “z=“qrs”” is added to “Φ” at 110. Along PATH 1, the value of the program variable “d” is determined at line 5 of the code, which corresponds to 108. Therefore, the expression “w=z+“t”” is added to “Φ” at 108. Note that because “z=x+y,” the expression for “w” may be rewritten as “w=x+y+“t”.” 108 is the end of PATH 1, and thus, the expression of “Φ” at 108 represents the conditions, in symbolic form, that need to be satisfied in order to reach the end of execution PATH 1. Similarly, 110 is the end of execution PATH 2, and thus, expression of “Φ” at 110 represents the conditions, in symbolic form, that need to be satisfied in order to reach the end of PATH 2.

Since program “foo” has two possible execution paths, symbolically executing program “foo” results in two sets of expressions corresponding to each execution path. In particular embodiments, solving for the expression of “Φ” at 108 may provide the actual values for the input variables “a” and “b” that cause program “foo” to reach the end of PATH 1; and solving for the expression of “Φ” at 110 may provide the actual values for the input variables “a” and “b” that cause program “foo” to reach the end of PATH 2. The function “foo” has only a few lines of code, mainly for illustrative purposes. However, in other situations, the software under analysis may have many variables and many lines of code.

In some embodiments, the expressions obtained from symbolically executing a software program (e.g., “Φ” at 108 and 110 in FIG. 1) may be solved using a solver. For example, a solver for solving symbolic expressions may be implemented based in part on the Satisfiability Modulo Theories (SMT). In some embodiments, a SMT solver may take as input a symbolic expression, which may include any number of constraints that need to be satisfied in order to proceed down a specific path in the software program, and attempt to find one or more solutions that satisfy all the constraints from the symbolic expression. A symbolic expression may not have any solution that satisfies all the constraints in the expression, in which case the expression is considered unsatisfiable or unsolvable. In some embodiments, the outputs from the SMT solver may be used as test cases for formally testing and validating the software program.

As the above example illustrates, symbolic execution is a software program analysis technique that starts the execution of a software program on symbolic, rather than concrete inputs, and it computes the effect on the software program on these symbolic inputs using symbolic expressions (e.g., the symbolic expressions represented by “Φ” in FIG. 1). Symbolic execution characterizes each path in a software program it explores with a path condition defined as a conjunction of Boolean expressions. Each Boolean expression denotes one branching decision made during the execution of a distinct path of the software program, for example PATH 1 and PATH 2, which may be represented by an execution state within the symbolic execution. Each of the execution states within the symbolic execution may encode a path condition at a branching condition and the values of variables in the path condition at the time of the branching condition.

Encoding information about a path condition within a symbolic execution state allows for backtracking to branching conditions so that additional branches stemming from the branch condition may be symbolically executed. For example, a symbolic execution state may represent a path condition up to and/or including the branching condition in line 4. When symbolically executing the function “foo,” one branch, lines 5 and 6, stemming from the branching condition in line 4 may be symbolically executed and then the symbolic execution may revert back to line 4 and symbolically execute the other branch, line 8, also stemming from the branching condition in line 4. The symbolic execution state may be copied to be included in both a first path condition executing lines 5 and 6 and a second path condition executing line 8.

Generally, symbolic execution states may be copied, matched, and shared as a software program is symbolically executed to cover all of or a majority of the branches within the software program. Alternately or additionally, during symbolic execution, backtracking through and searching of the symbolic execution states may occur. Alternately or additionally, stacks, frames, objects, and virtual heaps for each of the symbolic execution states may be managed within the symbolic execution.

When symbolic execution is finished, multiple path conditions may be generated, each corresponding to a feasible execution path of the code in the software program with respect to a symbolic input. Solutions to these conditions may be test inputs to the software program.

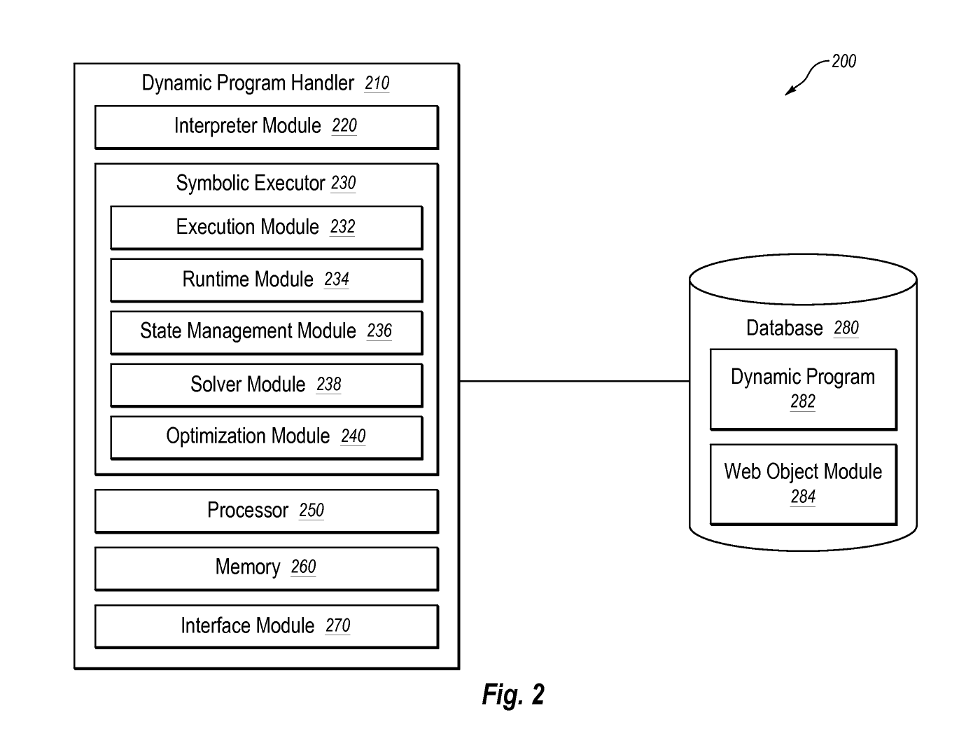

FIG. 2 is a block diagram of an example system 200 for symbolically executing a dynamic program 282, arranged in accordance with at least some embodiments described herein. The system 200 may include a dynamic program handler 210 that is communicatively coupled to a database 280 directly or indirectly through a network or through one or more other devices. The dynamic program handler 210 may include, but is not limited to, an interpreter module 220, a symbolic executor 230, a processor 250, a memory 260, and an interface module 270. The dynamic program handler 210 may be configured so that the interpreter module 220, the symbolic executor 230, the processor 250, the memory 260, and the interface module 270 may communicate with each other and share information. The database 280 may include the dynamic program 282 which the dynamic program handler 210 may symbolically execute.

The dynamic program 282 may be any program that is written using a dynamic programming language that executes at runtime many common behaviors that static programming languages may perform during compilation. Some examples of dynamic programming languages include, but are not limited to, JavaScript, Perl, Python, Ruby, BASIC, Dylan, Fancy, Lua, and Lisp, among others.

The dynamic program handler 210 may be configured to access the dynamic program 282 and data from a web object module 284 from the database 280 to allow the modules within the dynamic program handler 210 to perform operations on the dynamic program 282 and use the data from the web object module 284.

The interpreter module 220 may be configured to receive the dynamic program 282 from the database 280 and to translate the dynamic program 282 into some intermediate syntax. The dynamic program 282 is a high-level language with a complicated syntax. The interpreter module 220 may translate the dynamic program into an intermediate syntax that allows for easier symbolic execution of the dynamic program 282. In some embodiments, the interpreter module 220 may translate the dynamic program 282 into bytecode or some other type of intermediate syntax. After translating the dynamic program 282, the interpreter module 220 may send the intermediate syntax of the dynamic program 282, referred to herein as “dynamic syntax,” to the symbolic executor 230.

In some embodiments, the dynamic program 282 may contain web components, such as a HTML document object module (“DOM”) reference and/or a browser reference. The interpreter module 220 may be configured to translate the DOM and/or browser reference into an intermediate format using data from the web object module 284. The web object module 284 may be configured to store one or more prototypes, data structures, object models, or other information on DOM and/or browser reference accessible to the dynamic program 282. In some embodiments, the interpreter module 220 may translate the DOM and/or browser reference while translating the dynamic program 282. In some embodiments, the interpreter module 220 may translate the DOM and/or browser reference after sending the dynamic syntax to the symbolic executor 230. In these and other embodiments, the symbolic executor 230 may request the translation of the DOM and/or browser reference during symbolic execution of the dynamic syntax.

The web object module 284 may be implemented by any suitable mechanism. In some embodiments, the web object module 284 may be implemented by a parser from the EnvJS simulated browser environment, such as an html5/xml parser. The web object module 284 may be configured to provide models for any suitable object, including HTML DOM objects such as Document, Events, Elements, Anchor, Area, Base, Body, Button, Form, Frame/IFrame, or browser objects such as Windows, Navigator, Screen, History, or Location.

The symbolic executor 230 may be configured to receive the dynamic syntax, which is the intermediate syntax of the dynamic program 282, from the interpreter module 220, and to symbolically execute the dynamic syntax. To perform symbolic execution of the dynamic syntax, the symbolic executor 230 may include various modules, such as an execution module 232, a runtime module 234, a state management module 236, a solver module 238, and an optimization module 240.

The execution module 232 may be configured to symbolically execute the dynamic syntax to generate symbolic expressions that represent the different path conditions within the dynamic syntax. When symbolically executing the dynamic syntax, the execution module 232 may explore different paths through the dynamic syntax. The different paths through the dynamic syntax may result from different sequences of statements and/or function calls that may be followed based on conditional branch points within the dynamic syntax. For each branching condition within the dynamic syntax, the execution module 232 may generate a symbolic execution state, referred to herein as a “state.” Multiple states may be generated based on the configuration of branching conditions within the dynamic syntax.

The execution module 232 may maintain the states of the symbolic execution. Each state may contain all the components and/or information of a machine execution state such as frame that may include a stack, a virtual heap, a path condition, and/or an interface to an external environment.

In some embodiments, the execution module 232 may not rely on external symbolic executors to maintain states and/or control the symbolic execution of the dynamic syntax. In these and other embodiments, the execution module 232 may update the states. More specifically, a stack within the execution module 232 may map named or unnamed variables within the dynamic syntax to their symbolic values. The symbolic values may be objects and/or symbolic expressions. Alternately or additionally, a virtual heap within a state may be organized differently than a virtual heap in a physical graphic processing unit memory. For example, a physical memory in a physical graphic processing unit memory may map addresses to bytes or words of data. In contrast, the virtual heap within the execution module 232 may map variables and/or other portions of the dynamic syntax, such as field members, to objects and/or symbolic expressions.

To symbolically execute the dynamic syntax, the execution module 232 may symbolically execute each instruction within the dynamic syntax and update a current state of the symbolic execution according to a semantic of the instruction being executed. An example algorithm, which is below, illustrates symbolic execution of some basic instructions. The basic instructions may include load, add, compare, equals, and end.

```
while (true) {
  instr = current instruction;
  if (instr = “load”) then
    load data from the virtual heap and write it into the stack;
  else if (instr = “add”) then
    pop two operands from the stack and push their sum into the stack;
  else if (instr = “compare”) then
    pop two operands from the stack and push the comparison into the
    stack;
  else if (instr = “equals”) {
    if (the constraint c can be satisfied)
      then spawn a new state by adding c into the path condition;
    if (the constraint ~c can be satisfied)
      then spawn a new state by adding ~c into the path condition;
  }
  . . .
  else if (instr = “end”)
    backtrack to a previous state in the symbolic execution
}
```

The execution module 232 together with the state management module 236 may also handle various state management operations rising from symbolically executing the dynamic syntax, including state spawning, state copying and/or cloning, state matching, state sharing, state scheduling, state searching, and/or state backtracking While managing states during symbolic execution, the execution module 232 may also manage the components within each state, such as stacks, frames, path conditions, objects, and virtual heaps. For example, when a branching condition occurs within the dynamic syntax, two states may be spawned based on a parent state containing the branching condition. One state may be spawned for the path condition when the branching condition evaluates as true. Another state may be spawned for the path condition when the branching condition evaluates as false. The spawned states may include a stack, a frame, and a virtual heap similar to or the same as the parent state. The spawned states may also have path conditions similar to path conditions of the parent state but that include additional conditions based on the branching statement evaluating as true and false, respectively. The new spawned states may be maintained within a state tree and scheduled for execution when backtracking occurs by the state management module 236.

By managing these state management operations, such as state scheduling and state backtracking, during execution of the dynamic syntax, the symbolic executor 230 may not re-execute the dynamic syntax after reaching an end instruction or reaching the end of a path within the dynamic syntax. Instead, as illustrated above in the example algorithm, the execution module 232 may symbolically execute all of or a majority of paths within the dynamic syntax through state management. The management of the states and the components within the states may also account for characteristics of the dynamic syntax. Various examples of certain characteristics of the dynamic syntax and how they are accounted for are discussed hereafter.

The ability to handle state management operations, manage stacks, frames, objects, and virtual heaps within states, and accounting for characteristics of dynamic languages differentiates the symbolic executor 230 from a symbolic fuzzer or a concolic executor that re-executes programs from the beginning after reaching an end condition. The symbolic executor 230 is also different from symbolic executors for static languages which do not account for characteristics of dynamic languages as explained hereafter.

In some embodiments, the execution module 232 may be configured to symbolically execute the dynamic syntax in conjunction with the runtime module 234. The runtime module 234 may be configured to provide further interpretation of the dynamic syntax for the execution module 232. Alternately or additionally, the runtime module 234 may be configured to facilitate symbolic execution of portions of the dynamic syntax, such as portions of the dynamic syntax that may not be included within syntax of static programs. For example, the runtime module 234 may maintain type and scope information of a variable and other runtime information that may be determined during execution of the dynamic syntax. In some embodiments, the runtime module 234 may perform native interpretation of the portions of the dynamic syntax. In other embodiments, the runtime module 234 may be configured to provide other assistance to the execution module 232.

As an example, the execution module 232 may interpret instructions within the dynamic syntax and managing states, while the runtime module 234 maintains the information that may be needed by static programs. For example, before the execution module 232 invokes a function call for a function within the dynamic syntax, the execution module 232 may consult the runtime module 234 about the function to obtain information about the function, including arguments and some runtime information about an execution environment of the function. After the invocation of this function, the information about the function may be stored in the runtime module 234. In some embodiments, the runtime module 234 may be configured to pre-process the function with respect to its semantics, parameters, and the scope thereof, and subsequent instructions. The runtime module 234 may then communicate with the execution module 232 to hand off processing of the function.

Any suitable mechanism may be used for the execution module 232 and the runtime module 234 to communicate and exchange information. In some embodiments, the execution module 232 and the runtime module 234 may include various application programming interface functions accessible by the other. In some embodiments, the execution module 232 may include the runtime module 234. In these and other embodiments, the execution module 232 may thus include the functionality of the runtime module 234.

Due to the nature of dynamic programs, and thus dynamic syntax of dynamic programs, the execution module 232 may perform additional operations that an execution module for a static program would not perform.

For example, to perform symbolic execution, symbolic variables are declared for variables declared in a program. To build a proper path condition during symbolic execution of a program, the symbolic variables within the path condition are assigned a type when they are declared. However, when variables are declared in dynamic programs, they are not assigned types. The type of a variable in a dynamic program is fluid and is determined at runtime when the variable is assigned data of a specific type and/or compared to a specific data type. This is illustrated below in sample code1 in Table 2.

TABLE 2
Sample Code1

| | |
|---|---|
| 1 | var s; |
| 2 | var s = “Example”; |
| 3 | if (s > “abc”) |
| 4 | print (“hello”); |
| 5 | if (s == 1) |
| 6 | print (“goodbye”); |

In sample code1, in line 1, the variable “s” is declared, but no type is assigned to the variable. In line 2, the variable “s” is assigned a string and is interpreted as a string. In line 3, the variable “s” is compared to a string and is interpreted as a string. In line 5, however, the variable “s” is compared to an integer and is interpreted as an integer.

To compensate for declared variables that lack a declared type in a dynamic syntax, the execution module 232 may declare symbolic variables of unknown types. After declaring symbolic variables of unknown types, the execution module 232 may select a variable type for the symbolic variable during symbolic execution of the dynamic syntax. In some embodiments, the variable type may be selected based on a frequency of types of constraints that are occurring in a current path condition being symbolically executed. In some embodiments, the variable type may be selected based on a runtime analysis of the frequency of types of constraints occurring in a current path condition. For example, for a path condition where the majority of the variables are compared or assigned integers, the variable type selected for a symbolic variable of unknown type may be an integer.

Due to the type of a symbolic variable being able to change during symbolic execution, the execution module 232 may convert the symbolic variable to a correct type during execution to compensate for a change in type. For example, as illustrated in the sample code1, the type of the variable “s” changes from a string to an integer. In this example, the variable “s” may be assigned the type string and when used as an integer, the variable “s” may be converted to an integer during runtime to allow for proper variable tying during symbolic execution of the sample code1 and solving of related symbolic constraints. For example, a constraint “s.toInt( )==1” may be added into the path condition. In some embodiments, the execution module 232 may be assisted by the runtime module 234 in selecting, maintaining, and converting the type for variables of a dynamic syntax being dynamically executed. For example, in these and other embodiments, the runtime module 234 may establish and maintain the type, syntax, and other information about a variable. The execution module 232 may maintain information about the variable relevant to symbolic execution. Thus, an access to the variable in the dynamic syntax being symbolically executed may first trigger a delegation to the runtime module 234 to determine a type or type conversion, and then an access by the execution module 232 to the actual or symbolic value.

Another example of additional operations that the execution module 232 may perform for dynamic syntax that would not be performed for static syntax is determining a heap structure being used by objects being symbolically executed. An object of a program may be a variable, a statement, a function, or a data structure within the dynamic syntax.

Before execution of an object in a static syntax, the memory allocation for an object is known. In a dynamic syntax, the memory allocation of an object is not known before runtime. The objects in a dynamic syntax are dynamic and connected through scopes and references, such as pointers, and determined at runtime of the dynamic syntax. Not knowing the memory allocation for an object before runtime may present problems when manipulating and/or analyzing states of the symbolic execution. In particular, not knowing the memory allocation for an object before runtime may prevent copying, cloning, matching, or other functions, such as detecting state duplication, performed with respect to different states of the symbolic execution.

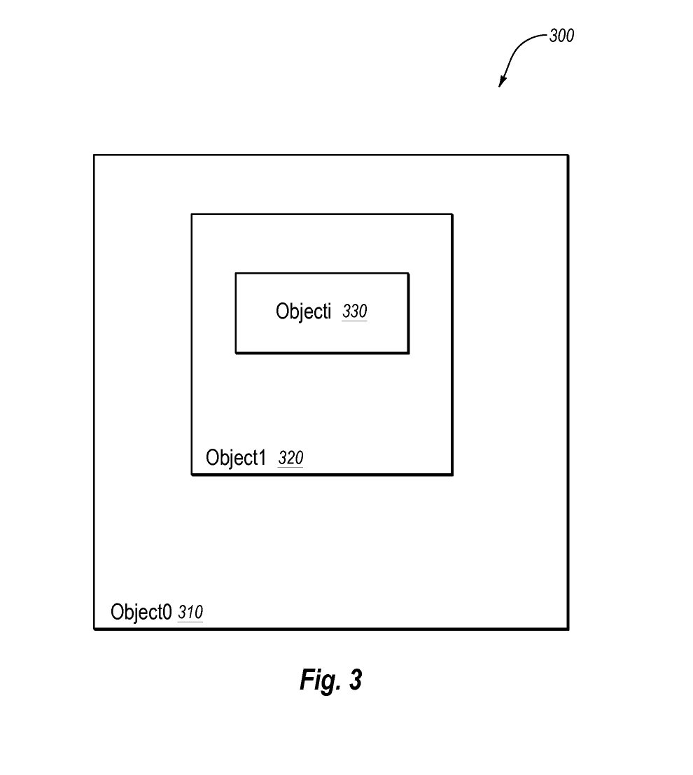

To allow for manipulating states of the symbolic execution, when an object is encountered when executing a dynamic program, an object map representing a hierarchical memory structure within the dynamic program is created that determines other objects that may be within the scope of the encountered object and/or be referred by the encountered object. The scope of the encountered object may be determined at runtime based on the execution of the dynamic syntax. The object map may be created using point-to analysis or some other analysis to determine when an object points to another object. A hierarchical memory structure 300 within a dynamic program is illustrated in FIG. 3. As illustrated, a first object, object0, may have a scope 310. A second object, object1, may be included within the scope 310 of the object0. The object1 may have a scope 320. Subsequent objects, such as object1, may be included within the scope 320 and have a scope 330. As illustrated, the scope 310 of the object0 may include the object1 and subsequent objects, such as object1. An object map created for object0 may represent the interdependencies between the object0 and the object1 and other objects within the scope 310 of object0. In general, an object map may capture the hierarchical structures of virtual heaps in a dynamic language.

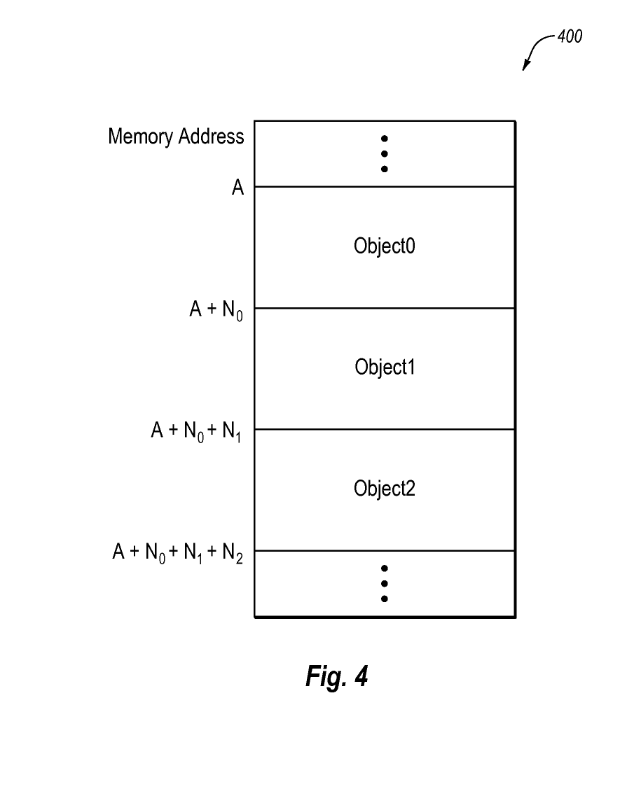

Static programs do not require hierarchical memory structures because all variables are known after compilation of the static program and before runtime. A flat memory structure 400 within a static program is illustrated in FIG. 4. As illustrated, a first object, object0, may start at memory location A and have a memory allocation of N₀. A second object, object1, may start at memory location A+N₀ and have a memory allocation of N₁. A third object, object2, may start at memory location A+N₀+N₁ and have a memory allocation of N₂. To copy the objects in the static program, the memory locations from A to A+N₀+N₁+N₂ may be copied. If there are pointers and/or other connections between the objects, these pointers and/or other connections between the objects may be ignored.

When symbolically executing dynamic syntax, however, the hierarchical structures of virtual heaps in the dynamic syntax may be maintained. As a result, pointers between objects within the virtual heap may be followed to identify objects and to maintain the objects in the right hierarchical structures. Furthermore, copying states and other state management operations may include determining a memory allocation of the hierarchical structure at runtime. Determining the memory allocation may be performed using a point-to analysis or some other analysis that determines how an object points to another object in a hierarchical structure, as illustrated in FIG. 3. Similar analysis may be followed when comparing and sharing states.

Returning to FIG. 2, in some embodiments, an object map for a first object may be constructed by determining second objects within a scope of the first object and then determining third objects within the scope of the second objects and continuing to determine additional objects until no further objects may be determined. In some embodiments, an object map may be limited to a certain number of objects or may only determine objects within so many hierarchical layers of the original object.

Based on the object maps constructed for the various objects, the execution module 232 may manipulate states in the symbolic execution. For example, to copy a state, the execution module 232 may copy memory referenced by the dynamic syntax included in the state as well as the memory for objects included within object maps for objects within the state. As another example, when detecting state duplication, objects within a state as well as objects included within object maps for the objects within the state may be compared to determine duplicative states.

Manipulating symbolic execution states may involve the use of large amounts of processing resources, such as memory, especially when copying symbolic execution states. To reduce the processing resources, data portions of the symbolic execution states may be copied to a new symbolic execution state and a pointer to code portions of the symbolic execution states may be used in the new symbolic execution state to avoid copying the code portions of the symbolic execution state. A data portion may be a portion of the dynamic program that is changing, such as a variable with changing values. A code portion may be a portion of the dynamic program that is relatively stable.

Code and data portions in a dynamic program are not separated such as in a static program. A dynamic program typically does not distinguish between data and code portions. In some embodiments, the execution module 232 may label portions of dynamic syntax it receives as a data portion or a code portion to reduce the processing resources used to manipulate symbolic execution states as described above. The execution module 232 may label portions of the dynamic syntax as a data portion or a code portion based on a classification of the portions by the interpreter module 220. The execution module 232, however, may monitor the code portions of the dynamic syntax during symbolic execution of the dynamic syntax. When the execution module 232 determines that a labeled code portion is changing and acting as a data portion, the execution module 232 may label the code portion as a data portion. Along with relabeling the changing code portion as a data portion, in some embodiments, the execution module 232 may determine symbolic execution states that include a reference to the changing code portion and provide a copy of the changing code portion to these symbolic execution states.

For each variable, statement, function, structure, or other object that is symbolically executed by the execution module 232, the execution module 232 may perform none or one or more of the above-described processes, such as assigning types, checking types, converting types, distinguishing between code and data portions, checking code portions for changes, determining scopes, constructing object maps, among others, before symbolically executing the variable, statement, function, structure, or other object.

The state management module 236 may be configured to assist the execution module 232 in managing symbolic execution states as dynamic syntax is symbolically executed as described herein. For example, the state management module 236 may provide assistance with respect to managing a state tree that includes information about the relationships between symbolic execution states and may provide information to allow the execution module 232 to manipulate the symbolic execution states. In some embodiments, the symbolic executor 230 may not include the state management module 236. In these and other embodiments, the execution module 232 may perform the functionality provided by the state management module 236.

The solver module 238 may be configured to receive symbolic expression generated by the execution module 232. The solver module 238 may be further configured to solve the symbolic expression to generate test inputs that may be used to test the execution paths of the dynamic program.

The optimization module 240 may be configured to optimize the symbolic execution of a dynamic program. In particular, the optimization module 240 may be configured to reduce the overhead to perform the processes described above, such as assigning types, checking types, converting types, distinguishing between code and data portions, checking code portions for changes, determining scopes, constructing object maps, among others. Alternatively or additionally, the optimization module 240 may perform various other optimizations to reduce a processing time and/or processing resources for symbolically executing a dynamic program.

In some embodiments, the optimization module 240 may be configured to optimize the symbolic execution by applying optimizations to functions within a dynamic program being optimized. For example, in some embodiments, the optimization module 240 may determine if a specific function is receiving constant inputs. During symbolic execution of a dynamic program, in some instances, symbolic inputs to a function may be constant because they are based on internal constants or other values within the program that do not change. When a function receives constant inputs, the function may be translated into machine code and executed. In some embodiments, the machine code may be executed directly on hardware. The results of executing the machine code of the function may be returned as the results of the function and used during the symbolic execution of the remaining portions of the dynamic program. The direct execution of the machine code may reduce the processing time and processing resources compared to symbolically executing the function. In some embodiments, translating the function into machine code may be performed using just-in-time compilation techniques for dynamic languages.

As another example, in some embodiments, the path condition resulting from symbolically executing a function with a first set of inputs may be cached. When the function is symbolically executed a second time with a set of inputs that match the first set of inputs, the cached path condition may be used in place of symbolically executing the function for a second time. In some embodiments, the inputs may be complicated objects whose structures and relations may be determined by object maps described above.

As another example, in some embodiments, a function within a dynamic program may be converted into a static function that is described using a static language. When a function may be converted into a static function, a symbolic executor for a static language used to describe the static function may be used to determine a path condition as well as a relation between the function input and output for the static function. The determined path condition and relation from the static function may be used in place of symbolically executing the function from the dynamic program. Since the symbolic execution of static programs may be faster than that of dynamic ones, this optimization may improve performance for some functions.

As another example, in some embodiments, a symbolic summary of the function may be determined. A symbolic summary of a function may be a symbolic expression of the contents of the function. The symbolic summary may be added to a current path condition. The symbolic summary may be determined before symbolically executing a dynamic program and applied to a path condition one or more times when the function is called during symbolic execution. Alternately or additionally, the symbolic summary may be created when the function is symbolically executed during symbolic execution of a dynamic program that includes the function. In these and other embodiments, the symbolic summary may be used in place of further symbolic executions of the function.

The processor 250 may be configured to execute computer instructions that cause the dynamic program handler 210 to perform the functions and operations described herein. The computer instructions may be loaded into the memory 260 for execution by the processor 250 and/or data generated, received, or operated on during performance of the functions, and operations described herein may be at least temporarily stored in the memory 260.

The interface module 270 may be configured to receive data from and/or to send data to other systems, users, and/or other processes over any type of communications network. In some embodiments, the interface module 270 may be configured to receive the dynamic program 282 and to store the dynamic program 282 in the database 280 and/or the memory 260.

The interpreter module 220 and the symbolic executor 230 may each be implemented in any suitable manner, such as a program, software, library, application, script, function, software-as-service, analog or digital circuitry, or any combination thereof. Modifications, additions, or omissions may be made to the dynamic program handler 210 without departing from the scope of the present disclosure. For example, the dynamic program handler 210 may be configured to have any number of different modules that assist in the symbolic execution of dynamic programs.

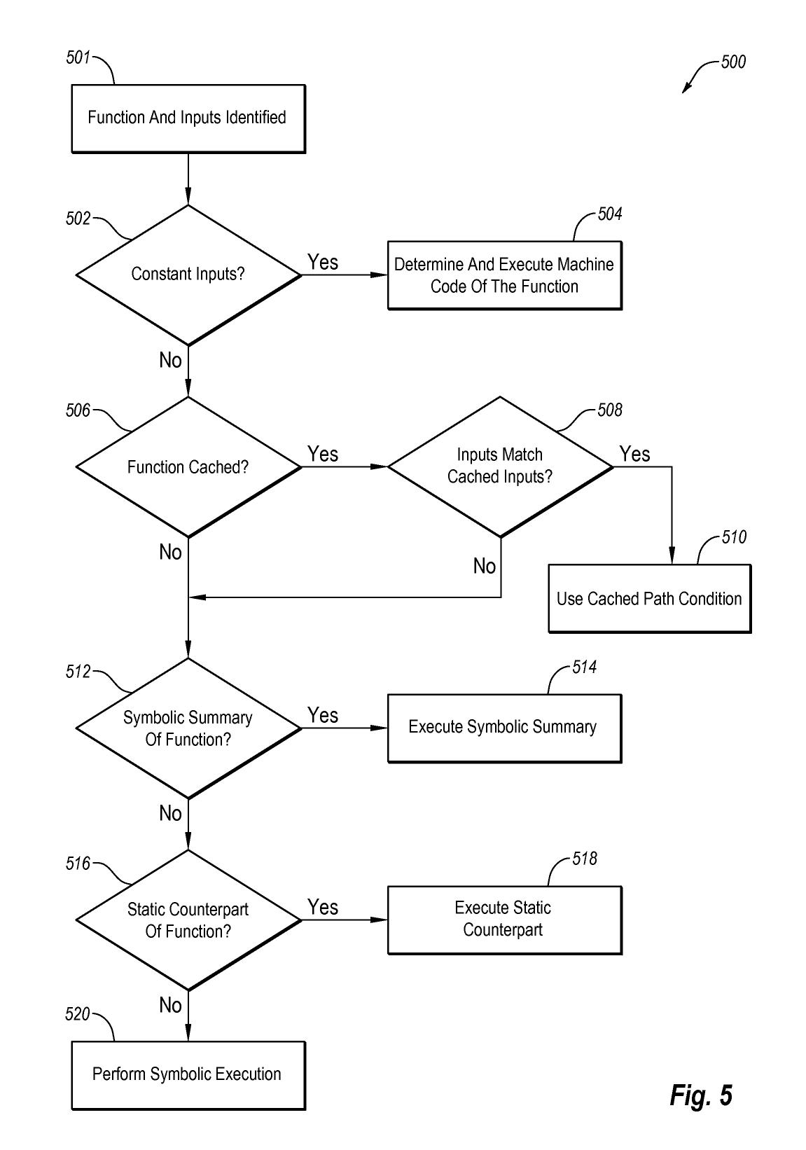

FIG. 5 is a flowchart of an example method 500 of optimizing symbolic execution of a dynamic program, arranged in accordance with at least some embodiments described herein. In particular, the method 500 may optimize symbolic execution of a dynamic program by optimizing the symbolic execution of functions within the dynamic program. The method 500 may be implemented, in some embodiments, by a system, such as the system 200 for symbolically executing a dynamic program of FIG. 2. Although illustrated as discrete blocks, various blocks may be divided into additional blocks, combined into fewer blocks, or eliminated, depending on the desired implementation.

The method 500 may begin at block 501, where a function and inputs to the function may be identified during symbolic execution of a dynamic program. For example, during symbolic execution of the dynamic program, a function may be called with certain inputs to the function. Calling of the function may identify the function and the inputs.

In block 502, it may be determined if the identified inputs are constant. When the identified inputs are constant inputs, the method 500 may proceed to block 504. When the identified inputs are not constant inputs, the method 500 may proceed to block 506.

In block 504, the machine code for the function may be determined and executed. The results of executing the function may be used in place of symbolically executing the identified function with the identified inputs and may be returned as the results of the function and used during the symbolic execution of the remaining portions of the dynamic program.

In block 506, it may be determined if a path condition for the function and inputs for the path condition have been cached. When the path condition and the inputs have been cached, the method 500 may proceed to block 508. When the path condition and inputs have not been cached, the method 500 may proceed to block 512.

In block 508, it may be determined if the identified inputs match the cached inputs. To match, the identified inputs and the cached inputs may not be the same. For example, in some embodiments, the cached inputs may be parameterized such that they may be instantiated and match with various different inputs.

When the identified inputs match the inputs used to determine the cached path condition, the method 500 may proceed to block 510. When the identified inputs do not match the inputs used to determine the cached path condition, the method 500 may proceed to block 512.

In block 510, the cached path condition and a relation between the input and output for the function may be used in place of symbolically executing the identified function with the identified inputs. The path condition and the relation may be returned as the results of the function and used during the symbolic execution of the remaining portions of the dynamic program.

In block 512, it may be determined if there is a symbolic summary of the identified function. When there is a symbolic summary of the identified function, the method 500 may proceed to block 514. When there is not a symbolic summary of the identified function, the method 500 may proceed to block 516.

In block 514, the symbolic summary of the function may be symbolically executed to generate a path condition and a relation between an input and an output. The path condition and the relation may be returned as the result of the function and used during the symbolic execution of the remaining portions of the dynamic program.

In block 516, it may be determined if there is a static counterpart of the identified function. When there is a static counterpart of the identified function, the method 500 may proceed to block 518. When there is not a static counterpart of the identified function, the method 500 may proceed to block 520.

In block 518, the static counterpart of the identified function may be symbolically executed to determine a path condition and a relation between an input and an output for the identified function. The path condition and the relation may be returned as the result of the function and used during the symbolic execution of the remaining portions of the dynamic program.

In block 520, the symbolic execution of the function may be performed as described above with respect to FIG. 1. For example, symbolic execution of the function may include determining an object map for the function and/or any objects within the function, determining types and/or converting the type of one or more variables within the function, and symbolically executing the function to determine a path condition for the function.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. For instance, the method 500 may further include additional optimizations for a function of a dynamic program than those described.

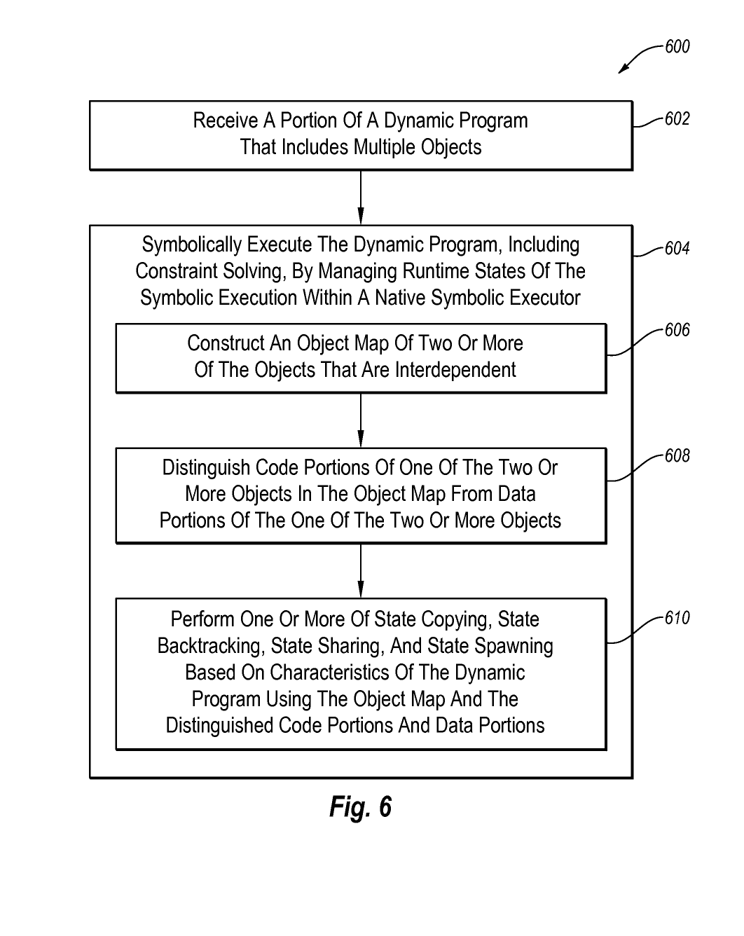

FIG. 6 is a flowchart of an example method 600 of symbolically executing a dynamic program, arranged in accordance with at least some embodiments described herein. The method 600 may be implemented, in some embodiments, by a system, such as the system 200 for symbolically executing a dynamic program of FIG. 2. Although illustrated as discrete blocks, various blocks may be divided into additional blocks, combined into fewer blocks, or eliminated, depending on the desired implementation.

The method 600 may begin at block 602, where a portion of a dynamic program that includes multiple objects may be received. Each of the objects may be one of a variable, a statement, a function, a data structure, or some other portion of the dynamic program.

In block 604, the dynamic program may be symbolically executed, including constraint solving, by managing runtime states of the symbolic execution within a native symbolic executor. Managing the runtime states of the symbolic execution may include blocks 606, 608, and 610.

In block 606, an object map of two or more of the objects that are interdependent may be constructed. The object map may be constructed based on the scope of the two or more objects being interdependent. For example, one of the two or more objects may be included within the scope of the other of the two or more objects creating the interdependency between the objects.

In block 608, code portions of one of the two or more objects in the object map may be distinguished from data portions of the one of the two or more objects.

In block 610, one or more of state copying, state backtracking, state sharing, and state spawning may be performed based on characteristics of the dynamic program using the object map and the distinguished code portions and data portions. In some embodiments, performing the state copying may include generating a copy of a state by copying the data portions of the one of the two or more objects and the two or more objects in the object map.

In some embodiments, managing the runtime states of the symbolic execution may further include declaring a symbolic variable of an unknown variable type for a variable of at least one of the objects. In some embodiments, the object may be the variable and may have an unknown type. In some embodiments, the object may be a statement, function, data structure, or some other object that includes the variable. In some embodiments, a variable type for the symbolic variable may be selected. In these and other embodiments, the variable type may be selected based on a variable type predominately being used in an object containing the symbolic variable. For example, when statements near to the symbolic variable are comparing integers, the integer variable type may be selected for the symbolic variable. Alternately or additionally, the variable type may be randomly selected. Alternately or additionally, the variable type may be selected based on a variable type selected for other symbolic variables near the symbolic variable.

Managing the runtime states of the symbolic execution may further include retyping the symbolic variable based on a type of an object of the dynamic program associated with the symbolic variable. For example, when the symbolic variable has an integer type and is being compared in an object to a string, the symbolic variable may be retyped as a string.

In some embodiments, when symbolically executing the dynamic program and the dynamic program includes a function with constant inputs, the method 600 may include compiling the function into machine code and executing the machine code. Alternately or additionally, when symbolically executing the dynamic program and the dynamic program includes a function, the method 600 may include caching the symbolic results of the function.

In some embodiments, the method 600 may include calculating a symbolic summary of a function in the dynamic program. In these and other embodiments, when symbolically executing the dynamic program, the symbolic summary of the function may be executed based on symbolic inputs to the function. Alternately or additionally, the method 600 may include converting a function in the dynamic program to a static function. In these and other embodiments, when the dynamic program is being symbolically executed, the static function may be executed in place of the function.

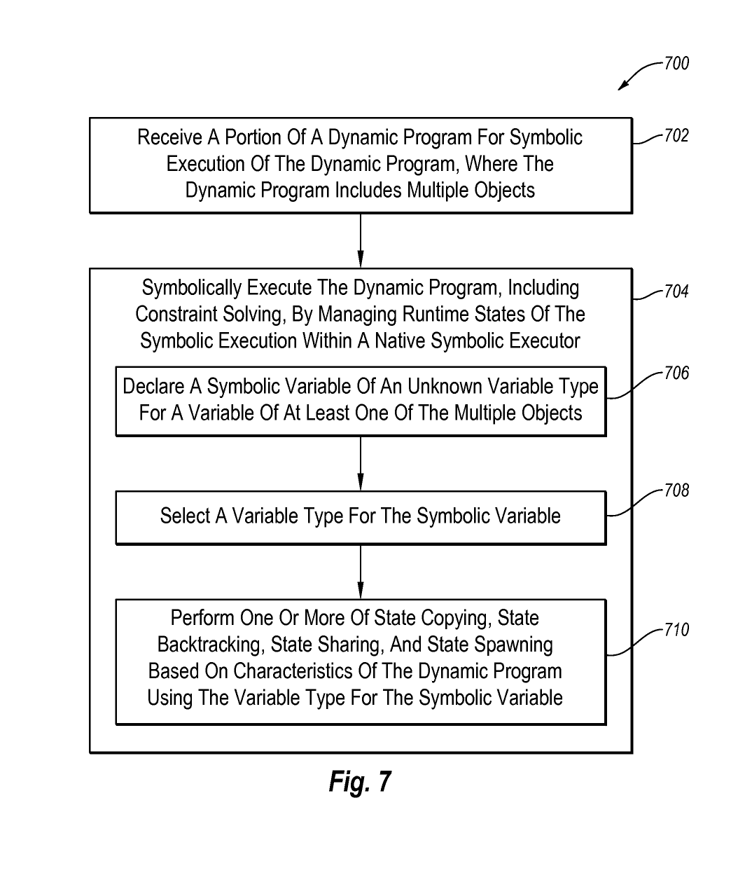

FIG. 7 is a flowchart of another example method 700 of symbolically executing a dynamic program, arranged in accordance with at least some embodiments described herein. The method 700 may be implemented, in some embodiments, by a system, such as the system 200 for symbolically executing a dynamic program of FIG. 2. Although illustrated as discrete blocks, various blocks may be divided into additional blocks, combined into fewer blocks, or eliminated, depending on the desired implementation.

The method 700 may begin at block 702, where a portion of a dynamic program for symbolic execution of the dynamic program may be received where the dynamic program includes multiple objects.

In block 704, the dynamic program may be symbolically executed, including constraint solving, by managing runtime states of the symbolic execution within a native symbolic executor. Managing the runtime states of the symbolic execution may include blocks 706, 708, and 710.

In block 706, a symbolic variable of an unknown variable type may be declared for a variable of at least one of the multiple objects. In block 708, a variable type for the symbolic variable may be selected.

In block 710, one or more of state copying, state backtracking, state sharing, and state spawning may be performed based on characteristics of the dynamic program using the variable type for the symbolic variable.

In some embodiments, managing the runtime states of the symbolic execution may further include constructing an object map of two or more of the objects that are interdependent and distinguishing code portions of the two or more objects in the object map from data portions of the two or more objects. In these and other embodiments, the one or more of state copying, state backtracking, state sharing, and state spawning may be performed based on the object map and the distinguished code portions and data portions.

In some embodiments, during symbolic execution of the dynamic program, the method 700 may further include compiling the function into machine code and executing the machine code when the dynamic program includes a function with constant inputs. Alternately or additionally, during symbolic execution of the dynamic program, the method 700 may further include caching symbolic results of a function of the dynamic program, executing a symbolic summary of the function of the dynamic program, or executing a static equivalent of the function.

The embodiments described herein may include the use of a special purpose or general purpose computer, including various computer hardware or software modules, as discussed in greater detail below.

Embodiments described herein may be implemented using computer-readable media or computer-readable storage media for carrying or having computer-executable instructions or data structures stored thereon. Such computer-readable media may be any available media that may be accessed by a general purpose or special purpose computer. By way of example, and not limitation, such computer-readable media may comprise tangible computer-readable storage media including RAM, ROM, EEPROM, CD-ROM or other optical disk storage, magnetic disk storage or other magnetic storage devices, or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically-recited examples and conditions. Although embodiments of the present inventions have been described in detail, it should be understood that the various changes, substitutions, and alterations could be made hereto without departing from the spirit and scope of the invention.

What is claimed is:

1. A method of symbolically executing a dynamic program, the method comprising:
receiving a portion of a dynamic program comprising a plurality of objects;
symbolically executing the dynamic program including constraint solving by managing runtime states of the symbolic execution within a native symbolic executor, managing the runtime states of the symbolic execution comprising:
constructing an object map of two or more objects of the plurality of objects that are interdependent;
distinguishing code portions of one of the two or more objects in the object map from data portions of the one of the two or more objects; and
performing one or more of state copying, state backtracking, state sharing, and state spawning based on characteristics of the dynamic program using the object map and the distinguished code portions and data portions.

2. The method of claim 1, wherein each object of the plurality of objects is one of a variable, a statement, a function, and a data structure.

3. The method of claim 1, wherein managing the runtime states of the symbolic execution further comprises declaring a symbolic variable of an unknown variable type for a variable of at least one of the plurality of objects and selecting a variable type for the symbolic variable.

4. The method of claim 3, wherein performing the state copying includes generating a copy of a state by copying the data portions of the one of the two or more objects and the two or more objects in the object map.

5. The method of claim 1, wherein when symbolically executing the dynamic program and the dynamic program includes a function with constant inputs, the method further comprises compiling the function into machine code and executing the machine code.

6. The method of claim 1, wherein when symbolically executing the dynamic program and the dynamic program includes a function, the method further comprises caching the symbolic results of the function.

7. The method of claim 1, further comprising calculating a symbolic summary of a function in the dynamic program, wherein when symbolically executing the dynamic program, the symbolic summary of the function is executed based on symbolic inputs.

8. The method of claim 1, further comprising converting a function in the dynamic program to a static function, wherein when symbolically executing the dynamic program, the static function is executed in place of the function.

9. A computer-readable storage media including computer-executable instructions configured to cause a processing device to perform operations to symbolically execute a dynamic program, the operations comprising:
receiving a portion of a dynamic program comprising a plurality of objects;
symbolically executing the dynamic program including constraint solving by managing runtime states of the symbolic execution within a native symbolic executor, managing the runtime states of the symbolic execution comprising:
constructing an object map of two or more objects of the plurality of objects that are interdependent;
distinguishing code portions of one of the two or more objects in the object map from data portions of the one of the two or more objects; and
performing one or more of state copying, state backtracking, state sharing, and state spawning based on characteristics of the dynamic program using the object map and the distinguished code portions and data portions.

10. The computer-readable storage medium of claim 9, wherein each object of the plurality of objects is one of a variable, a statement, a function, and a data structure.

11. The computer-readable storage medium of claim 9, wherein managing the runtime states of the symbolic execution further comprises declaring a symbolic variable of an unknown variable type for a variable of at least one of the plurality of objects and selecting a variable type for the symbolic variable.

12. The computer-readable storage medium of claim 9, wherein performing the state copying includes generating a copy of a state by copying the data portions of the one of the two or more objects and the two or more objects in the object map.

13. The computer-readable storage medium of claim 9, wherein when symbolically executing the dynamic program and the dynamic program includes a function with constant inputs, the operations further comprise compiling the function into machine code and executing the machine code.

14. The computer-readable storage medium of claim 9, wherein when symbolically executing the dynamic program and the dynamic program includes a function, the operations further comprise caching the symbolic results of the function.

15. The computer-readable storage medium of claim 9, the operations further comprising calculating a symbolic summary of a function in the dynamic program, wherein when symbolically executing the dynamic program, the symbolic summary of the function is executed based on symbolic inputs.

16. The computer-readable storage medium of claim 9, the operations further comprising converting a function in the dynamic program to a static function, wherein when symbolically executing the dynamic program, the static function is executed in place of the function.

17. A method of symbolically executing a dynamic programming language, the method comprising:
receiving a portion of a dynamic program for symbolic execution of the dynamic program, the dynamic program comprising a plurality of objects;
symbolically executing the dynamic program including constraint solving by managing runtime states of the symbolic execution within a native symbolic executor, managing the runtime states of the symbolic execution comprising:
declaring a symbolic variable of an unknown variable type for a variable of at least one of the plurality of objects;
selecting a variable type for the symbolic variable; and
performing one or more of state copying, state backtracking, state sharing, and state spawning based on characteristics of the dynamic program using the variable type for the symbolic variable.

18. The method of claim 17, wherein managing the runtime states of the symbolic execution further comprises:
constructing an object map of two or more objects of the plurality of objects that are interdependent; and
distinguishing code portions of the two or more objects in the object map from data portions of the two or more objects, wherein the one or more of state copying, state backtracking, state sharing, and state spawning is performed based on the object map and the distinguished code portions and data portions.

19. The method of claim 17, wherein during symbolic execution of the dynamic program when the dynamic program includes a function with constant inputs, the method further comprises compiling the function into machine code and executing the machine code.

20. The method of claim 17, wherein during symbolic execution of the dynamic program, the method further comprises caching symbolic results of a function of the dynamic program, executing a symbolic summary of the function of the dynamic program, or executing a static equivalent of the function.
